(19) United States
(12) Patent Application Publication
(10) Pub. No.: US 2009/0168733 A1
(43) Pub. Date: Jul. 2, 2009

(54) Wireless Access Points

(75) Inventors: David Niall MacFadyen, Cheshire (GB); David Thomas, Chester (GB)

Correspondence Address: BAKER & DANIELS LLP, 300 NORTH MERIDIAN STREET, SUITE 2700, INDIANAPOLIS, IN, 46204, US

(73) Assignee: TYCO ELECTRONICS UK LTD, WILTSHIRE (GB)

(21) Appl. No.: 12/226,250

(22) PCT Filed: Apr. 4, 2007
(86) PCT No.: PCT/GB2007/001250

§ 371 Date: Oct. 10, 2008

(30) Foreign Application Priority Data
Apr. 13, 2006 (GB) 0607413.2
Aug. 8, 2006 (GB) 0615705.1

(51) Int. Cl. H04W 84/02

(52) U.S. Cl. 370/338

(57) ABSTRACT

A floor chamber (11) for use in building construction includes a cavity (13) and a movable lid (14) supporting one or more electronic components (17) and/or an aerial (19) whereby to define at least part of an access point in or on the floor chamber. An in-use upper side of the cavity is openable and closeable on moving of the lid (14). The arrangement provides a convenient wireless access point that is integral with a floor chamber. A floor construction including one or more floor members defining a floor and including therein a wireless access point and a floor-level wireless access point network are also described, the floor-level wireless access point network comprising two or more access points connected together by an under-carpet cable system.

This invention concerns improvements in or relating to wireless access points.

An “access point” is an installation comprising electronic components, cabling, and one or more transmitters and receiver aerials so as to permit wireless access of computers and other electronic devices to the permanently installed data networks.

US2005/0152306 A1 summarises the nature of access points, and mentions that they are commonly configured to operate according to so-called “WiFi” protocols.

Hitherto, access points have been wall-mounted. US2005/0152306 suggests the possibility of installing specifically a WiFi access point in or relative to a standard switch and/or outlet box at any level of a wall, ceiling or floor.

In recent years increasingly it has become commonplace to incorporate wireless data communication access points into buildings. These allow users of portable computers and other electronic devices incorporating suitable transmitter-receiver and data handling components to connect e.g. to the Internet or to a building network, without requiring a physical cable connection.

Various protocols (such as IEEE standard 802.11, which relates to so-called “WiFi” wireless networks) exist for the provision of access points, but all require inter alia one or more aerial components (for communicating data with the user's device); certain electronic components that perform tasks such as signal conditioning and screening; and a power supply for powering the electronic components to permit transmission of data to the devices of users via the aerial. The invention as defined herein at least potentially relates to all types of access point.

In most buildings it is important, for successful operation of a WiFi or other wireless network, to provide multiple access points in order to achieve good spatial coverage of the data signals. This need for multiple access points in turn causes a requirement to incorporate data cabling, into the building, in order to connect the access points to the building data network. Desirably, from the standpoints of ease of construction, safety/security and aesthetics, the cabling is buried within the building walls.

Although in new buildings such burying of cabling is possible, it can be expensive and in any event is difficult to re-configure after the building is constructed. In pre-existing buildings it is often impossible to provide the data cabling except in a form secured to the surfaces of the walls. This conflicts with the cabling desiderata indicated above.

Furthermore the access points typically are located above head height in order to minimise their visual impact and to maximise uninterrupted coverage of the signals in a building space. Above-head height mounting however causes problems when it is necessary to repair or otherwise work on the access points.

According to the invention in a first aspect there is provided a wireless access point comprising a floor chamber including a cavity; and a movable lid supporting one or more electronic components and/or an aerial whereby to define at least part of the wireless access point in or on the floor chamber, a side of the cavity being openable and closeable by moving of the lid.

Such an arrangement advantageously permits the construction of a floor box of a known kind described herein below, having additionally at least part of the functionality of an access point (when the lid omits the aerial, which may be provided externally of the floor box yet connected to the electronics) or the entire functionality of an access point (when the lid includes both the electronic components and the aerial).

A further possibility, within the scope of the invention, is for the lid to incorporate or support an aerial; and for further electronic components to lie externally of the floor box and lid while being operatively connected to the aerial.

The aerial may also be a remote aerial, in communication with the remaining components of the access point at a distant location, for instance the access point may be stored in a communications cupboard.

According to an alternative aspect of the invention there is provided a wireless access point comprising a floor chamber including a cavity; and a movable lid supporting one or more electronic components and/or an aerial remotely located from the access point whereby to define at least part of the wireless access point in or on the floor chamber, a side of the cavity being openable and closeable by moving of the lid.

The aerial may alternatively be a distributed antenna system (DAS), as is known in the art, such systems offer the advantage of wireless coverage over a unit area with reduced total power and improved reliability as a single high power aerial is replaced by a group of low power antenna/aerials. As a result, less power is wasted in overcoming penetration and shadowing losses.

Each of these configurations has the advantage that the electronics present in the floor box may be simpler, smaller and more reliable because the access point electronics have been moved to a dedicated space at a remote location where they are less likely to be damaged. As a result, the overall system offers improved reliability through a reduction in the possibility of physical damage to the component parts thereof.

A floor chamber typically is configured to enclose or support standard outlets for electrical power connections and/or data cabling access in the floor spaces of buildings.

Herein “floor chamber” is intended to include within its scope any chamber formed or defined in a floor, but the invention is of particular applicability in the case of a chamber configured as a rigid, self-supporting cuboid having an openable cover.

The rigid walls of the cuboid, which are typically made from a metal such as steel, galvanised tin or plastics materials, define a cavity. Inside the cavity an outlet platform spanning the walls beneath the level of the cover supports one or more outlet sockets of appropriate design for receiving electrical power plugs and data cable plugs (such as but not limited to the well-known RJ11 and RJ45 types).

Such chambers are commonly known as “floor boxes”. They are widely used in the construction of office and other commercial spaces in which raised floors include beneath them voids in which electrical and data cabling, and pipework, extend as needed. Cabling types may include but are not limited to UTP cables, mains wiring cables, fiber optic cables and co-axial cables.

The outlet sockets are connectable, during construction of a floor, to the cables extending through the under-floor voids. Thus a plurality of the floor boxes enclose outlets providing power and/or data cable connection points at convenient locations that may be obscured as desired by closing the openable covers. The covers themselves may include openable flaps via which appliance cables may pass to and from the outlets when the covers are closed.

Floor boxes as described are known to be advantageous since they can be manufactured in large numbers away from a construction site and installed as needed.

Also the nature of known floor box designs is such as to confer great flexibility as to the layout of a floor. This is because in many commercial buildings the raised floors are defined by rigid tiles supported on a metal framework so as to create the mentioned under-floor voids. The tiles are removable and are of the same surface area as the floor boxes. Therefore wherever it is required to provide electrical and/or data connection points it is a simple matter to insert one of the floor boxes in place of one of the tiles. This additionally permits easy re-configuring of a floor after it has been constructed.

In theory the invention also is of utility in floor chambers constructed in other ways (such as by the casting of a hollow chamber in a concrete floor); although the invention is of primary benefit in such floor boxes as defined hereinabove.

The invention is beneficial because:
(i) the floor boxes intentionally are unobtrusive;
(ii) they are connected to power and network data cabling, thereby avoiding the difficulties of providing such cabling as noted above;
(iii) maintenance of the access points is facilitated because (a) the components are at a convenient (floor-level) height; and (b) the openable cover permits ready access to interior parts (such as the electronic components).

Preferably the floor chamber is defined by the said lid and at least one wall in use depending downwardly from the lid to define the cavity.

Thus the invention embraces within its scope the preferred form of floor chamber, ie. a floor box that may be manufactured away from a building site and installed as needed in a floor.

The invention extends to a variety of forms of the downwardly depending wall, although the most preferred arrangement is one including at least three generally flat walls depending downwardly from the lid, adjacent pairs of the generally flat walls being interconnected to define side walls of the cavity.

Even more preferably, there are four such generally flat walls, defining a cuboidal overall shape of the floor chamber.

Preferably the floor chamber includes at least one member within the cavity spanning at least two of the walls at a level that is spaced from the lid.

Thus preferred embodiments of the floor chamber of the invention include the support member (outlet platform) that is conventional in known floor box designs.

The floor chamber of the invention may additionally include a lowermost member whose purpose is to provide an in-use bottom wall of the cuboidal shape.

The walls of the floor chamber may of course be perforated as needed to allow cables to pass into and out of the cavity. Any such perforations may be provided with grommets or glands whose purpose is to prevent or minimise damage to such cables.

Conveniently the or each wall is manufactured from a rigid material whereby the chamber is a self-supporting item. Thus the floor chamber may advantageously adopt many of the characteristics of known floor boxes.

The lid preferably is retainable hingeably captive relative to a wall of the cavity. It is also preferable that the lid and a wall of the cavity are releasably securable one relative to the other.

The floor chamber may include a hinge securing the lid and a wall of the cavity one relative to another, the hinge including hinge parts secured respectively on the lid and the said wall that are releasably connectable one to another.

These features confer flexibility on the floor chamber of the invention in use (since it is possible to remove the lid either for repair or replacement of the components supported thereby, or simply to permit more ready, unhindered access to the cavity of the floor chamber as desired). Additionally the removability of the lid allows the lid to be manufactured separately from the remainder of the components defining the floor chamber. This in turn permits installation of the lid as a “retro-fit” item, in replacement of a conventional lid of a floor box.

Preferably the lid includes one or more of the electronic components secured to a side of the lid that on closing faces towards the cavity.

This feature advantageously protects the electronic components against damage eg. through liquid or dust ingress, or accidental impacts. Moreover when the lid is, as in preferred embodiments of the invention, made of metal it may readily be arranged to function as a heat sink for the electronic components.

Conveniently the floor chamber includes a power supply and a power connection for operatively connecting one or more electronic components supported by the lid to the power supply.

It is also preferable that the lid supports the connection. The lid may in addition support the power supply components if desired, as part of an electronics package secured to it.

In a particularly preferred embodiment of the invention the lid includes an aerial secured to a side that in use of the lid to close a side of the cavity is an upper side.

Placing the aerial on the in-use upper side of the lid may advantageously provide a dielectric between the aerial and any electronics components supported on the underside of the lid. This in turn assists in avoiding corruption of data signals conveyed using the apparatus of the floor chamber.

The floor chamber may optionally include an aerial connection for operatively connecting together an aerial and one or more electronic components when supported by the lid. Such connection preferably is supported by the lid.

Overall, therefore, the parts of the lid provide a beneficially compact arrangement by means of which the functions of an access point are available, without the disadvantages of the prior art access points.

In an alternative arrangement, the aerial may lie externally of the lid and be connected by the said connection to one or more of the electronic components supported by the lid.

Such a mode of construction permits the extent of the aerial, over a floor area, to be chosen according to the requirements of an access point designer.

This is particularly beneficial, since in certain applications it is needed to have a large aerial area (for example when the overall power output of the access point is low); whereas in certain other applications (eg. when the access point power output is higher) a smaller aerial, extending a lesser distance from the floor chamber or over a lesser area of the floor space, is appropriate.

It is also advantageous to provide the aerial as e.g. a directional or an omni-directional aerial. To the latter end, in one embodiment of the invention at least part of the floor chamber is electrically conducting and is connected via a ground connection so as to define a ground plane for the electronic components.

The invention is also considered to reside in a floor construction including one or more floor members defining a floor including therein a wireless access point as defined hereinabove comprising a floor chamber and a lid and an aerial lying externally of the floor chamber and connected via an aerial connector to one or more said electronic components supported by the lid, wherein the aerial extends across part of the floor.

In such a construction, the aerial may be or may include a length of dispensed tape including one or more signal-receiving and/or transmitting elements.

Such features allow for a particularly flexible flooring arrangement, in which a floor box defining a floor chamber according to the invention may be incorporated in place of a rigid floor tile, and a dispensed tape aerial be connected to the floor box such that the aerial occupies a floor area that is optimised for the floor construction in question.

In an arrangement falling within the scope of the invention the aerial may be received in a recess in the lid and connected e.g. by means of wires passing through a through-going aperture formed in the lid or a wall of the floor box. By this means the aerial can be readily connected to electronics components inside the floor box.

In such arrangements the aerial may underlie, or overlie, each of the floor members at the option of the access point designer.

Regardless of whether the aerial overlies or underlies the floor members, the floor construction may optionally include one or more further flooring members overlying the floor above the aerial. The further flooring members may be eg. carpet tiles, rolls of carpet, or other flooring materials.

In particularly preferred embodiments the aerial may extend in a labyrinthine pattern across the floor; or alternatively in a T-shape across part of the floor. Other shapes and patterns of the aerial element are possible within the scope of the invention.

Another possibility is to provide the aerial so as to radiate and/or receive over one or more segments that are separated from further segments of the aerial by one or more radiating and/or non-receiving segments. This arrangement allows the designer of the apparatus to select those areas of a floor that are capable of radiating and/or receiving through:
(a) the choice of which parts of the aerial are “active”; and
(b) the choice of where, in the floor construction, to locate the active parts of the aerial.

In embodiments where the aerial is positioned remotely from the access point, or where the aerial is a DAS, the aerial may be connected to the access point using any wired method known in the art. For instance, the aerial may be connected to the access point using wiring already present in the building, such as is described in US 2005/0249245 (to Serconet Ltd) the contents of which is incorporated herein by reference to the extent that it does not conflict with the current disclosure. Additionally or alternatively, the aerial and access point may be connected using a passive coaxial link (such as the coaxial systems marketed by Mobile Access of Vienna in Virginia, USA) and/or using fiber optic cabling (such as the systems marketed by ZinWave of Cambridge in the UK).

Where a remote aerial or DAS is present, the access point may be located in the floor box or in an alternative location such as a store cupboard. Typically the aerial and not the remaining components of the access point will be located in the floor box as this reduces the possibility of damage to the access point components thereby making the system more robust. In addition, the electronics which must be fitted to or placed within the floor box can be simplified through alternative positioning of the access point components and the necessary size of the floor box reduced.

According an alternative aspect of the invention, there is provided a floor-level wireless access point comprising an under-carpet cable system and/or a floor chamber including a cavity and a movable lid movable to open and close a side of the cavity, and one or more electronic components and/or an aerial in communication with the under-carpet cable system or the lid, whereby to define at least part of the wireless access point in or on the under-carpet cable system and/or the floor chamber. In many embodiments the aerial will be attached to the under-carpet system, however the aerial may also be a remote aerial or a DAS as described above.

Under-carpet cable systems represent an alternative to conventional round cable for the wiring of commercial and industrial offices. They facilitate the distribution of power and/or communication cables at floor level without the limitations of under-floor ducts, walls, and utility poles. The flat, low-profile configuration allows the cable system to be installed directly on top of the floor (e.g. wood, ceramic, composition, or concrete) and then covered with carpet (e.g. carpet squares) or another type of floor covering. This provides a cable system which is not visible in use but which is easily accessible for maintenance purposes, or where the cabling requirements have changed. In addition, the use of such a system allows power and communications connections to be located away from the walls, an advantage in larger, particularly open-plan, offices where there are few work stations positioned near to walls.

Preferably, the under-carpet cable system comprises power and communications cables. Often, the communications cables are adapted to carry voice, data and video information. In particular, to offer telemetry services, cell phone services, RFID and/or security radio services.

In some embodiments, the under-carpet cable system includes transition blocks adapted to facilitate the transition of power or data cables from round cables to flat cables. These are typically located on or within the floor or on a wall at or near to floor level.

A further aspect of the invention resides in a floor construction including one or more floor members defining a floor and including therein a wireless access point as defined herein above comprising a floor chamber and lid and an aerial lying externally of the floor chamber and connected via an aerial connector to one or more said electronic components supported by the lid, wherein the aerial extends across part of the floor.

According to a further aspect of the invention, there is provided a chamber and lid as defined herein for forming a wireless access point also as defined herein.

There is further provided a floor-level wireless access point network comprising two or more access points as defined herein above connected together by an under-carpet cable system.

There is also provided a floor-level wireless access point network comprising two or more floor box mounted aerials connected to an access point as described herein above. Preferably connection will be remote connection.

The invention also resides in a lid as defined herein for a floor chamber also as defined herein to form a wireless access point as defined herein. Such a lid advantageously may include one or more hinge parts for securing the lid to a floor chamber. Each said hinge part optionally is releasably securable to a floor chamber.

The one or more said electronic components may be secured to a side of the lid that is in use an underside.

Preferably the lid includes a power connection for operatively connecting one or more electronic components supported by the lid to a power supply.

A lid according to the invention may include an aerial secured to a side that in use of the lid is an upper side; together with, optionally, an aerial connection for operatively connecting together an aerial and one or more electronic components when supported by the lid.

A further advantage of all aspects of the invention relates to the ability to upgrade e.g. the data transmission rate capacity of a wireless network.

The likelihood is that such upgrades would not require any alteration of the transmission frequency. Therefore during an upgrade there would be no need to replace the aerial. As a result the upgrade need involve merely changing the electronics components as needed. Since these are located on the lid of the floor box or near the floor box such exchange of components is facilitated.

Furthermore, several designs of access point electronics are available as discrete “packages” that may be supported on a floor box and operatively connected to the aerial supported in the lid. The use of such packages as a means of providing the access point electronics is within the scope of the invention and facilitates upgrades as outlined above.

It should be noted that each feature of the above invention may be used in combination with each of the other features without limitation as to described embodiment unless the contrary is expressly stated.

There now follows a description of preferred embodiments of the invention, by way of non-limiting example, with reference being made to the accompanying drawings in which:

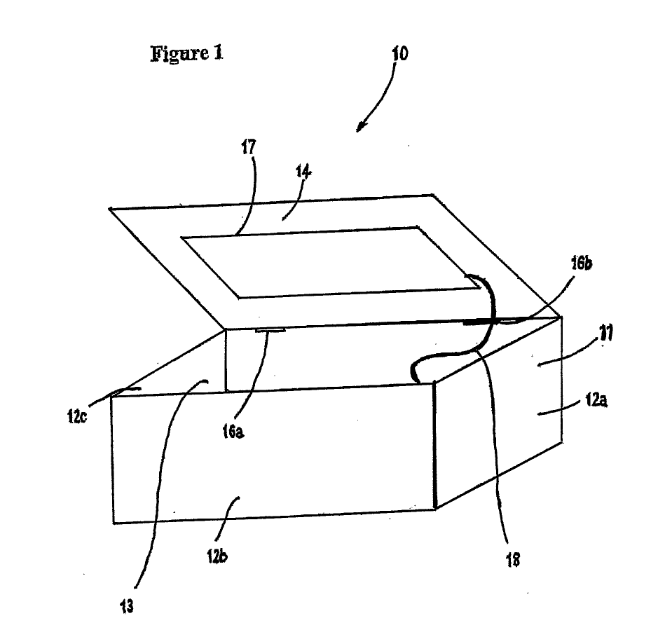

FIG. 1 is a perspective view of a floor chamber, according to the invention, showing an openable lid in an open position;

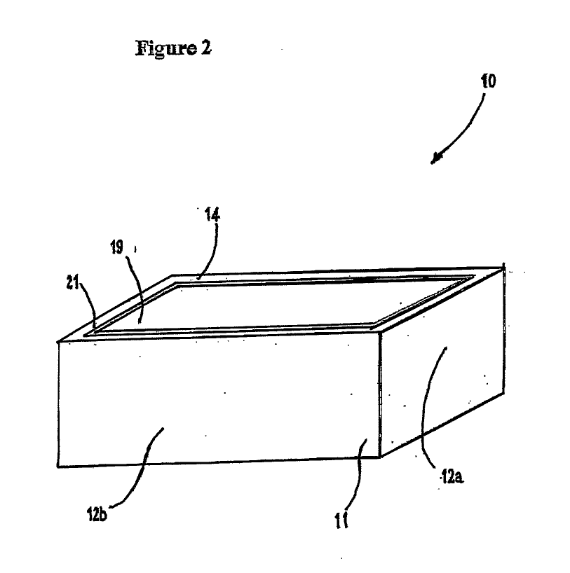

FIG. 2 is a perspective view of the FIG. 1 floor chamber; showing the lid in a closed position;

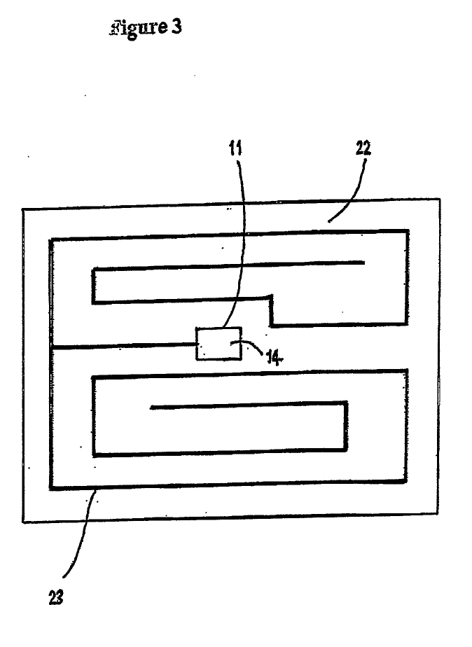

FIG. 3 is a schematic, plan view of a floor construction according to the invention;

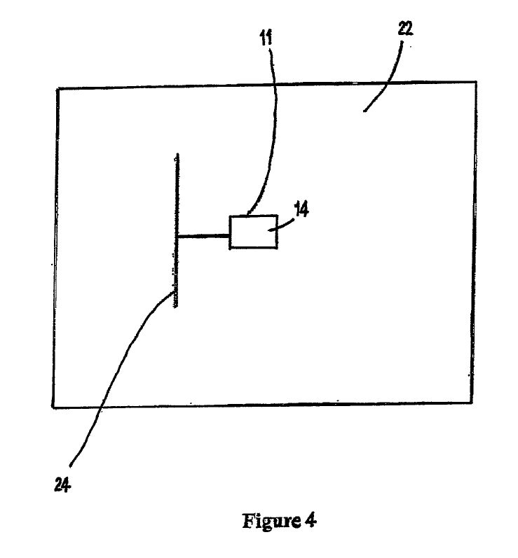

FIG. 4 is a schematic, plan view of a further floor construction according to the invention;

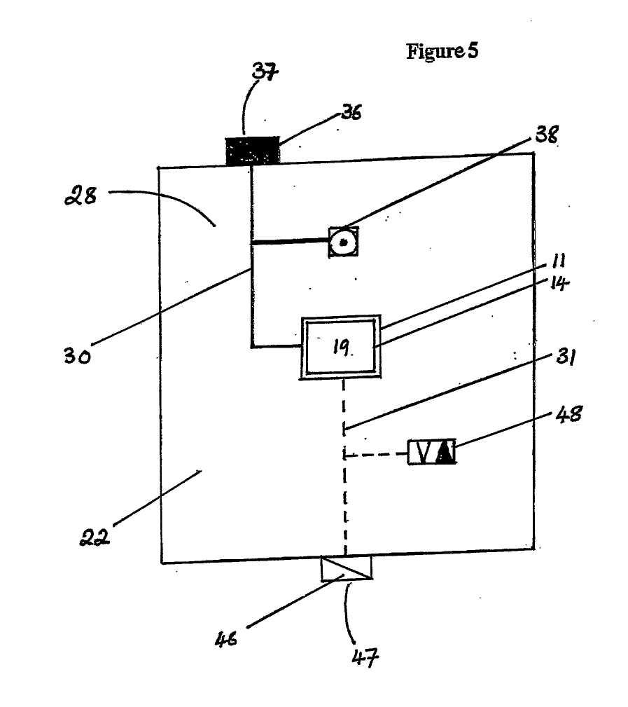

FIG. 5 is a schematic plan view of a floor construction including the wireless access point of the invention;

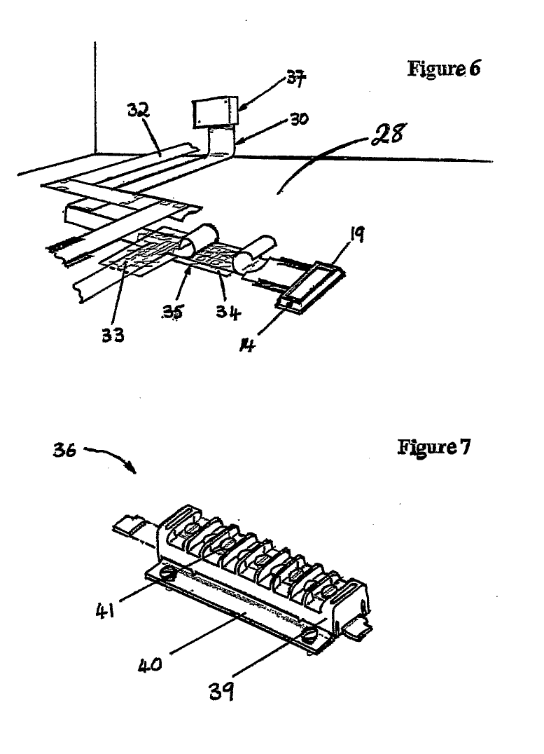

FIG. 6 is a schematic perspective view of a power cable system including the wireless access point of the invention;

FIG. 7 is a perspective view of a power transition block which forms part of the wireless access point of the invention;

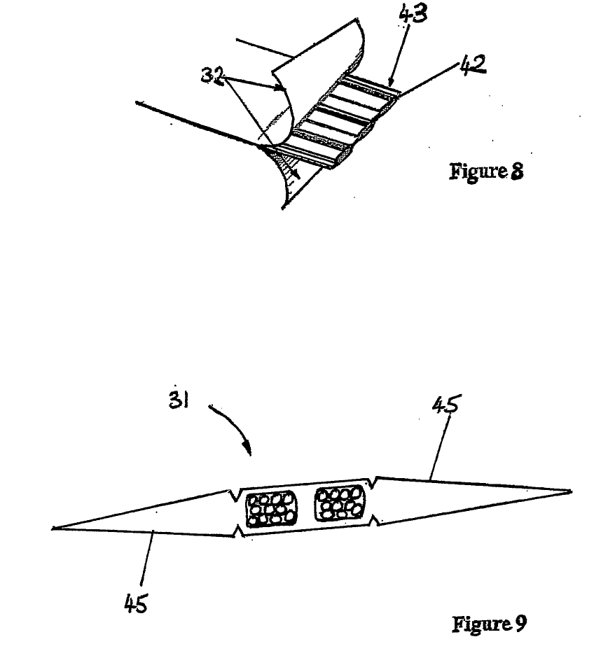

FIG. 8 is a perspective view of a power cable which forms part of the wireless access point of the invention;

FIG. 9 is an enlarged cross-sectional view through a communications cable which forms part of the wireless access point of the invention; and

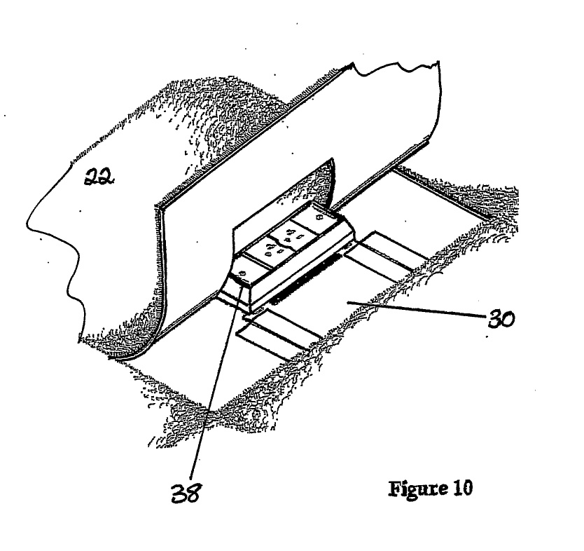

FIG. 10 is a perspective view of a power socket, installed in accordance with the invention.

Referring to the drawings and in particular to FIGS. 1 and 2, there is shown a floor chamber 10 that in the preferred embodiment shown is in the form of a floor box 11 having four mutually perpendicular, upstanding walls 12a, 12b, 12c, 12d that are rigidly secured one to another at corners to define a cuboidal cavity 13. The walls 12a-12d are themselves made of a rigid material such as but not limited to galvanised tin, steel or any of a wide selection of plastics materials.

Although a cuboidal cavity 13 is shown in the drawings, other cavity shapes (such as but not limited to cylindrical and ovaloid ones) are possible within the scope of the invention.

The cavity 13 is open at its in-use upper side as shown. This open side is closeable by means of a moveable lid 14 that is essentially a rigid plate hingedly secured along one side edge to an upper edge of one of the walls 12a-12d. In the particular embodiment shown in FIG. 1, the chosen wall is one of the longer walls, 12d, but in other embodiments alternative arrangements are possible.

Lid 14 is secured by way of hinges 16a, 16b as shown in FIG. 1.

The lid 14 supports on its in-use underside one or more electronic components represented schematically by numeral 17, which defines an area of the underside of the lid in which the electronics components may be mounted so as to be operable. The electronics components may be those of a WiFi of other type of access point, apart from the aerial of such a device. Thus the floor box 11 and lid 14 define at least part of an access point.

As best shown by comparison between FIGS. 1 and 2, the lid 14 is hingeable between open and closed positions, such that the open, in-use upper side of the floor box is selectively openable and closeable.

Although not shown in the figures, it is readily possible to incorporate into at least one of the walls 12a-12c and the lid 14 respectively, a catch, retainer or other closure device for selectively retaining the lid 14 in a closed position.

Also not visible in the drawing figures, the cavity 13 may include spanning at least two of the walls 12a-12d (and in preferred embodiments all of them) a member defining a support for one or more sockets connected to respective data and power cables. The support may be modular, whereby to confer choice on the precise arrangement of power and data sockets available in a particular floor box according to the invention.

Numerous variations are possible in this regard. In particular, it is possible to provide power cabling for the socket outlets in a floor box forming part of the invention, together with separate network cabling for providing data connectivity via the access point components. In another arrangement however it is possible to provide power and data distribution via common cabling connected to the floor box. An example of such cabling arises in a so-called “Power-over-Ethernet” (“PoE”) installation and/or a data over power installation such as “Powerline”, in which data signals are transmitted over mains electrical wiring using frequency division multi placing techniques. The invention therefore is of utility in such installations.

Such a support member may be of a type that is conventional in known floor boxes.

A further feature of the arrangement of FIGS. 1 and 2 is that the hinges 16a-16b may if desired each include releasable parts disposed respectively on the wall 12d (in the example shown) and the lid 14, such that the lid 14 may be detached completely from the floor box 11. The hinges may be arranged so that such removal may occur only when the lid 14 occupies a particular angular orientation relative to the floor box 11. For example, complete removal of the lid 14 may be possible only when the lid 14 is fully upright relative to the floor box 11.

As best shown in FIG. 1, one or more cables 18 may be provided in the floor chamber 10 for connecting the electronics components 17 to eg. a data network or power supply. Thus the lid 14 preferably includes a connection for connecting such cabling 18, that may exit from the floor box 11 via conventional apertures and glands for connection to the remainder of a data network or power supply.

In the FIG. 1 embodiment only a single cable 18 is visible. In practical versions plural cables would be present.

As best seen in FIG. 2, the lid 14 includes a rectangular region in which a WiFi access point aerial (not visible per se in the drawings) may be supported.

The region 19 may be eg. a recess formed in the upper surface of the lid 14. In an alternative arrangement, the aerial may be embedded in the material of the lid, especially if the lid material is non-metallic.

If on the other hand the lid is metallic it preferably is earthed. As a result the lid may serve as a ground plane for the aerial, thereby enhancing the effectiveness of the aerial under certain circumstances.

Thus FIG. 2 shows in schematic form a rectangular insulating region 21. In practice however this region may take any of a range of forms.

The floor chamber 10 includes an aerial connection for operatively connecting the aerial to eg. the electronic components 17. The connection may be of a per se known kind.

Thus the arrangement of FIGS. 1 and 2 incorporates the features of a WiFi access point conveniently into a floor box the construction of which in other respects is largely conventional.

In an alternative arrangement, however, the aerial need not occupy a designated area 19 of the lid 14 and may instead be external to the floor box 11.

Arrangements in which this is the case are shown in FIGS. 3 and 4.

The floor box 11 is shown located arbitrarily in the embodiment shown, approximately in the middle of a floor 22. Other locations are of course possible. Also the floor need not be rectangular in plan as shown.

An aerial 23 (FIG. 3) or 24 (FIG. 4) lies externally of the floor box 11 and is operatively connected to the electronic components 17 secured to the underside of the lid 14. This is achieved by means of the aerial 23/24 (or a cable connected thereto) extending through an aperture in a wall of the floor box 11 such that the aerial connection may be established, within the interior of the floor box 11.

In the FIG. 3 arrangement, the aerial 23 is elongate and labyrinthine. Therefore it extends over a substantial portion of the area of floor 22. Such an arrangement is suitable, when the power output of the electronic components is comparatively low. This arrangement allows maximum coupling of data energy between the aerial 23 and eg. the aerial of a WiFi card installed in a laptop computer.

In contrast in the FIG. 4 arrangement the power output of the electronics of the floor box 11 is somewhat higher. As a consequence, there is a need for only a comparatively small aerial 24 that in the embodiment shown in configured as a T-shape.

Numerous other aerial shapes and configurations are possible.

The floor box may be located at any of a range of locations in the floor. Furthermore, plural floor boxes 11 may be provided. In this regard however the floor boxes 11 are advantageous over wall-mounted access points since the floor boxes may be located more centrally relative to a group of users. Thus for a given number of users fewer of the floor boxes 11 are needed, compared to the number of wall-mounted access points required for equivalent coverage. This aspect of the invention is particularly advantageous in large, open-plan offices.

The aerial 23 or 24 as appropriate may lie under or over the rigid members defining the floor 22. Furthermore, the aerial may be eg. dispensed from a roll of metalised tape, having conducting components incorporated therein. This plus the above-described flexibility of installation of the floor boxes 11 allows for the easy construction of a customised floor arrangement using components manufactured in advance, away from the floor installation in question.

Regardless of whether the aerial overlies or underlies the members defining the upper surface of the floor, one or more flooring materials (such as rolls of carpet or carpet tiles) may be placed so as to overlie the floor and thereby provide an aesthetically pleasing, heat-insulative finish to the floor construction visible in FIGS. 3 and 4.

Appropriate apertures may in a per se known manner be provided in the lid 14. Furthermore the lid 14 may include retainers for retaining flooring materials thereon, so as to confer a uniform appearance on the floor as a whole.

Locating the aerial on or in the lid prevents the floor box (if made from an electrically conducting material) from functioning as a Faraday cage, which effect might otherwise prevent the access point from functioning correctly.

The various forms of the lid 14 may if desired be manufactured independently of the floor boxes 11.

Assuming that the lids 14 are manufactured with conventional, releasable hinge parts that are known per se in the flooring industry, it is possible to provide the lids 14 as “retro-fit” items. Thus it is possible to convert, using lids made in accordance with the invention, existing floor boxes to provide at least some of the functions of a WiFi access point. The question of whether all such functions are provided within a single lid depends on whether the aerial is incorporated into the lid (as in the arrangements shown in FIGS. 1 and 2); or is provided externally (as in the floor constructions of FIGS. 3 and 4).

Variations on the arrangements shown and described herein include, firstly, the use of a range of materials from which to manufacture the rigid walls of the floor box 11; and the lid 14.

Furthermore, as indicated herein, more or fewer than the four mutually orthogonal, upstanding walls of the floor box 11 are possible within the scope of the invention. Also possible is the use of a single, circular or ovoid wall that depends downwardly from a lid member to define a cylindrical or ovoid floor box shape.

With reference to FIG. 5, there is shown a floor construction in which the floor box 11 is arbitrarily illustrated approximately in the middle of a floor 22. An aerial (not shown in this figure) is present which occupies a designated area 19 of the lid 14 of the floor box 11. In alternative embodiments (not shown), the aerial may be external to the floor box 11 and operatively connected to the electronic components therein. Each of these aerial configurations is described in detail UK Patent Application No. 0607413.2, which disclosure is incorporated by reference.

In this embodiment, the floor box 11 forms part of a larger under-carpet power and communications cable system (generally designated 28) including a flat, flexible power cable 30 and an under-carpet communications cable 31. A shield 32, cable tapping 33 and splicing 34 connectors, and insulators 35 (best shown in FIG. 6) may be used with the cable system 28 of the invention as would be known to the person skilled in the art.

The transition from round wire to flat power cable 30 is made using insulation-piercing transition blocks 36 (illustrated in FIG. 7). These are preferably housed in transition fittings 37 which may be flush or surface mounted on any substantially flat area (whether vertical, horizontal or at an angle in between), although preferably they will be located on or within the floor 22 or on a wall at or near to floor level. Alternatively, the transition blocks 36 may be housed within a floor service box. In this embodiment the floor box 11 functions as both a wireless access point and as a floor service box. The floor service box provides access to the cable system 28 and functions as a distribution point for power and communication cables 30, 31.

The flat power cable 30 extends from the transition fitting 37 across the floor 22 surface where it may be connected to floor box 11 or other electric receptacles such as power sockets 38 or the like (FIG. 10). It should be noted that although a cuboidal transition fitting 37 is illustrated, other cavity shapes (for instance, cylindrical or ovaloid configurations) are possible within the scope of the invention. The transition fittings 37 may be made from a rigid material such as galvanised tin, steel or any of a wide selection of plastics materials. It is preferred that where steel is used, that this is zinc-plated.

The transition block 36, housed within the transition fitting 37 protects the area where the round supply cable connects to the flat power cable 30. Blocks 36 of this type are well known in the art and typically feature a plastics moulding incorporating copper-alloy terminals. Typically, this will be mounted on a zinc-plated steel base plate 40, although other metal or non-metal materials may be used. In this example a single screw 41 is present at each terminal and tightening of the screw 41 draws the base plate 40 towards the plastics moulding 39, bringing the round and flat cables 30 into electrical connection.

The flat power cable 30 may be integrated into the under-carpet cable system 28 in one or more sizes as appropriate for the load circuit to be serviced. It is also possible to provide an isolated ground (not shown) within the power cable facilitating the supply of a separate ground to sensitive equipment. The isolated ground is preferably channeled directly to the power source thereby preventing surges and noise from entering the circuit from other equipment.

The power cable 30 is constructed from flat copper conductors 42 which are placed, in preferred examples, side-by-side and then laminated with plastics strips 43 to separate and enclose the conductors 42, thereby providing the necessary insulation. This feature is most clearly illustrated in FIG. 8. The plastics strips 43 will typically be a polyester compound as polyesters are flame-retardant, offer appropriate dielectric properties are moisture resistant and robust. In this embodiment, the insulation between conductors 42 is perforated so that the conductors 42 may be separated without exposing the adjacent conductor 42. The power cable 30 is then, in this instance, protected using a vinyl shield 32 bonded to each side of the cable 30.

The cable 30 is brought into contact with a power output 38 via screws which are present on the output 38. These screws pierce the cable insulation, bringing the components into electrical contact. The power outputs 38 or other direct connecting receptacle (for instance, a device to be powered such as the floor box 11), are preferably low profile to minimise the trip hazard associated with the unit. Additionally, it is preferred that the direct connecting receptacle include a cover (not illustrated), to protect the receptacle when not in use. The cover will typically be biased to a closed position, often through the use of springs. However, other methods may also be used, as would be apparent to one skilled in the art.

Different flat power cables 30 may be spliced together, for instance where it is desirable to have a five way power cable 30 with a three way power cable 30 extending from this. This is achieved through the use of splice connectors 34 which allow the electrical connections to run between different rolls of cable 30. Typically these connectors 34 will be metallic, most preferably copper or of a copper-alloy material.

In this embodiment, where the conductors 42 of the power cables 30 are exposed, for instance through splicing, tapping, dead ending or through the removal of fittings, it is preferred that the area which has been altered is insulated using an additional insulator assembly 35. A preferred design is to place regions of insulator 35 around the splice or other unprotected region of the cable 30. Although any insulating material may be used, in this example the insulator 35 is foam which is bonded to vinyl on one side and covered with adhesive on the other, the adhesive being paper backed until use. By removing the paper backing and bonding two sections of insulator 35 together so that the faces with adhesive contact one another and form a bond around the open contacts of the power cable, the exposed sections of cable can be protected.

The wireless access point preferably also includes an under-carpet communication system. The term ‘communication system’ is intended to encompass both telephone and data cable 31 systems. Although a range of communications cable 31 designs are known, the communications cable 31 of this embodiment will typically be a twisted pair of unshielded cables 31 with a Category 5E performance. These cables will typically include ramped side wings 45 (as shown in FIG. 9), eliminating the need for top and bottom taping. Voice, data and video information can be carried using the cables 31 of this embodiment which are compatible with the ACO, SL and 110 Connect systems.

As with the transition fittings 37 for use with the power cables 30, the transition fittings 47 housing the communications cables 31 facilitate the transfer between round communications cables and flat communications cables 31 which are suitable for under-carpet use. As with the transition between round power cables to flat power cables 30, this transition utilizes transition blocks 46 which may be housed within the transition fittings 47 or within a floor service box. The transition block 46 will, in this specific example, be either an AMP-BARREL transition block, or a Category 5E transition 110 Block, both of which are well known in the art.

The transition fitting 47 may be flush or surface mounted on any substantially flat area, although preferably they will be located on or within the floor 22 or on a wall at a point at or near to floor level. The communications transition fitting 47 may be configured in a range of different shapes, however, typically it will be cuboidal as illustrated. The transition fitting 47 may be made from a rigid material such as galvanized tin, steel or any of a wide selection of plastics materials. However, it is preferred that the fitting is steel, usually zinc-plated steel.

The communication cables 31 extend from the transition fitting 47 across the floor 22 to connect floor box 11 or other communications devices 48, such as modular couplers, multimedia jacks (for instance, RCA multimedia jacks or SL series 110 Connector jacks), telephone sockets or SVGA connectors. These devices 48 are, in this example, low profile to minimise the trip hazard arising from their presence in the floor. The communications devices 48 will be housed in covered cavities with only the connectors to the communications devices 48 exposed (for instance the jack ports).

It will be understood that the under-carpet cable system 28 of the invention is a highly flexible system which may be used to provide multiple power and/or communications outputs 38, 48 and that these may be positioned as desired across an expanse of floor. In particular, there is no limit to the number of WiFi enabled floor boxes 11 which may be incorporated into the system.

1. A wireless access point comprising a floor chamber including a cavity; and a movable lid supporting one or more electronic components and/or an aerial whereby to define at least part of the wireless access point in or on the floor chamber, a side of the cavity being openable and closeable by moving of the lid.

2. A wireless access point comprising a floor chamber including a cavity; and a movable lid supporting one or more electronic components and/or an aerial remotely located from the access point whereby to define at least part of the wireless access point in or on the floor chamber, a side of the cavity being openable and closeable by moving of the lid.

3. A floor-level wireless access point comprising an under-carpet cable system and/or a floor chamber including a cavity and a movable lid movable to open and close a side of the cavity, and one or more electronic components and/or an aerial in communication with the under-carpet cable system or the lid, whereby to define at least part of the wireless access point in or on the under-carpet cable system and/or the floor chamber.

4. An access point according to claim 3 wherein the aerial is attached to the under-carpet cable system.

5. An access point according to any preceding claim, wherein the floor chamber is defined by the said lid and at least one wall in use depending downwardly from the lid to define the cavity.

6. An access point according to claim 5 including at least three generally flat walls depending downwardly from the lid, adjacent pairs of the generally flat walls being interconnected to define side walls of the cavity.

7. An access point according to claim 6 including at least one member within the cavity spanning at least two of the walls at a level that is spaced from the lid.

8. An access point according to any of claims 5 to 7 wherein the or each wall is manufactured from a rigid material whereby the chamber is a self-supporting item.

9. An access point according to any preceding claim wherein the lid is retainable hingedly, and preferably releasably, captive relative to a wall of the cavity.

10. An access point according to any preceding claim wherein the lid includes one or more said electronic components secured to a side of the lid that on closing of the lid faces towards the cavity.

11. An access point according to any preceding claim including a power supply and a power connection for operatively connecting one or more electronic components supported by the lid to the power supply.

12. An access point according to claim 10 wherein the lid supports the connection.

13. An access point according to any preceding claim wherein the lid includes an aerial secured to a side that in use of the lid to close a side of the cavity is an upper side.

14. An access point according to any preceding claim including an aerial connection, that is preferably supported by the lid, for operatively connecting together an aerial and one or more electronic components when supported by the lid.

15. An access point according to claim 14 including an aerial lying externally of the lid and connected by the said connection to one or more said electronic components supported by the lid.

16. An access point according to any preceding claim wherein at least a part of the floor chamber is electrically conducting and is connected via a ground connection so as to define a ground plane for the electronic components.

17. An access point according to any of claims 3 to 16 wherein the under-carpet cable system comprises power and communications cables.

18. An access point according to claim 17 wherein the communications cables are adapted to carry voice, data and video information.

19. An access point according to any of claims 3 to 18 wherein the under-carpet cable system includes transition blocks adapted to facilitate the transition of power or data cables from round cables to flat cables.

20. An access point according to claim 19 wherein the transition blocks are located on or within the floor or on a wall at or near to floor level.

21. An access point according to any of claims 3, 5 to 12, 14 and 16 to 20 wherein the aerial is remotely located from the access point.

22. An access point according to any of claims 3, 5 to 12, 14 and 16 to 20 wherein the aerial is a distributed antenna system.

23. An access point according to claim 21 or claim 22 wherein the aerial and the access point are connected using existing wiring systems, coaxial cable and/or fiber optic cable.

24. A floor construction including one or more floor members defining a floor and including therein a wireless access point according to any preceding claim comprising a floor chamber and lid and an aerial lying externally of the floor chamber and connected via an aerial connector to one or more said electronic components supported by the lid, wherein the aerial extends across part of the floor.

25. A floor construction according to claim 24 wherein the aerial is or includes a length of dispensed tape including one or more signal-receiving elements.

26. A floor construction according to claim 24 or claim 25 wherein the aerial either underlies the or each said floor member, or overlies the said floor member.

27. A floor construction according to any of claims 24 to 26 including one or more further flooring members overlying the floor and the aerial.

28. A floor construction according to any of claims 24 to 27 wherein the aerial extends in a labyrinthine pattern or in a T-shape across the floor.

29. A floor construction according to any of claims 24 to 28 wherein the aerial radiates and/or receives over one or more segments that are separated from further segments of the aerial by one or more non-radiating and/or non-receiving segments.

30. A floor chamber and lid as specified in any of claims 1 to 20 for forming a wireless access point according to any of those claims.

31. A lid as specified in any of claims 1 to 20 for a floor chamber to form a wireless access point according to any of those claims.

32. A floor-level wireless access point network comprising two or more access points according to any of claims 1 to 18 connected together by an under-carpet cable system.

33. A floor level wireless access point network comprising two or more floor mounted aerials connected to one or more access points as described in claims 21 to 23.

34. An access point network according to claim 32 or 33 additionally comprising one or more peripheral devices selected from power sockets, modular couplers, multimedia jacks, telephone sockets and SVGA connectors.

35. A floor chamber generally as herein described, with reference to and/or as illustrated in the accompanying drawings.

36. A floor construction generally as herein described, with reference to and/or as illustrated in the accompanying drawings.

37. A lid generally as herein described, with reference to and/or as illustrated in the accompanying drawings.

38. A wireless access point generally as herein described, with reference to and/or as illustrated in the accompanying drawings.
